(19) United States
(12) Patent Application Publication
(10) Pub. No.: US 2010/0151916 A1
(43) Pub. Date: Jun. 17, 2010

(54) METHOD AND APPARATUS FOR SENSING GRIP ON MOBILE TERMINAL

(75) Inventors: Jae-Myung BAEK, Suwon-si (KR); Dong-Hyun LEE, Seongnarn-si (KR); Kyung-Ho PARK, Suwon-si (KR); Gi-Tae MUN, Suwon-si (KR)

Correspondence Address: THE FARRELL LAW FIRM, LLP, 290 Broadhollow Road, Suite 210E, Melville, NY, 11747, US

(73) Assignee: Samsung Electronics Co., Ltd., Suwon-si (KR)

(21) Appl. No.: 12/638,507

(22) Filed: Dec. 15, 2009

(30) Foreign Application Priority Data
Dec. 15, 2008 (KR) 10-2008-0127251
Dec. 24, 2008 (KR) 10-2008-0133912

(51) Int. Cl. H04M 1/00

(52) U.S. Cl. 455/567; 455/550.1

(57) ABSTRACT

A method and apparatus for sensing a grip on a mobile terminal are provided, in which the mobile terminal is switched to a manner mode, when grip sensors on both side surfaces of the mobile terminal are touched simultaneously, upon receipt incoming call, the call is started, if a vicinity sensor senses the user's face nearby in the manner mode, and the call is ended, if the vicinity sensor senses that the user's face is receding from the mobile terminal.

### PRIORITY

This application claims priority under 35 U.S.C. §119(a) to a Korean Patent Application filed in the Korean Intellectual Property Office on Dec. 15, 2008 and assigned Serial No. 10-2008-0127251, and a Korean Patent Application filed in the Korean Intellectual Property Office on Dec. 24, 2008 and assigned Serial No. 10-2008-0133912, the contents of both of which are incorporated herein by reference.

### BACKGROUND OF THE INVENTION

1. Field of the Invention

The present invention relates generally to a method and apparatus for sensing gripping of a mobile terminal, and more particularly, to a method and apparatus for sensing gripping of a mobile terminal having gripping sensors and vicinity sensors, which provide a user interface for sensing gripping of and a grip pressure applied to, the mobile terminal.

2. Description of the Related Art

User interface devices generally include handheld devices for executing various application-based functions such as wireless communication, while being carried by a user. Examples of such handheld devices are a cellular phone, a Personal Digital Assistant (PDA), a smart phone, a Portable Multimedia Player (PMP), a laptop computer, a tablet Personal Computer (PC), a digital camera, and a camcorder. Typically, a handheld device refers to a device that operates while being held by a user.

Cellular phones have recently developed to the extent that they now integrate electronic device functions as well as main functions such as call origination and termination and text message transmission and reception. For instance, the cellular phone has many functions such as an Motion Pictures Experts Group (MPEG)-Layer Audio 3 (MP3) music file play function of an MP3 player, video recording and play function of a digital camera, an electronic dictionary function, and a digital Television (TV) function.

As a variety of functions are integrated into a handheld device, extensive studies have been required on a user interface for more conveniently invoking a user-intended function.

A mobile terminal rings or vibrates upon reception of an incoming call. Under some circumstances, the ringing sound or the vibration of the mobile terminal may be a disturbance to the user. This led to the development of a convenient user interface for fast switching to a manner mode, such as a silent mode-or vibration mode.

FIGS. 1A and 1B illustrate conventional methods for fast switching a mobile terminal to a manner mode, upon incoming of a call.

FIG. 1A illustrates a mobile terminal for fast switching to the manner mode using an acceleration sensor. Referring to FIG. 1A, the acceleration sensor senses when the mobile terminal is turned upside down, and switches the mobile terminal to the manner mode so that ring tones are changed into vibrations or muted, or vibrations are muted.

FIG. 1B illustrates a mobile terminal for fast switching to the manner mode using a motion sensor. Referring to FIG. 1B, upon movement of the user's hand over the mobile terminal, the motion sensor senses the motion and switches the mobile terminal to the manner mode so that ring tones are changed into vibrations or muted, or vibrations are muted.

As illustrated in FIGS. 1A and 1B, the acceleration sensor-based or motion sensor-based manner mode (e.g. silent mode or vibration mode) is immediately triggered when the mobile terminal is turned upside down or upon movement of the user's hand over the mobile terminal. However, the mobile terminal is ringing while the user identifies a caller, i.e. while the user reads a caller's number. Moreover, the transition to the manner mode is time-consuming when the mobile terminal is placed upside down or in a pocket.

FIG. 2 illustrates a conventional mobile terminal for sensing a user's grip on the mobile terminal by a temperature sensor and automatically connecting a call, as disclosed in Korean Patent Application No. 10-2003-0083143.

Referring to FIG. 2, this conventional temperature sensor-based grip sensing and automatic call connection scheme is difficult to use when temperature changes due to changes in the ambient temperature and/or power consumption of the mobile terminal. Also, since a call is connected immediately after the user grips the mobile terminal, it is difficult for the user to read a caller's number. While not shown, a scheme for automatically connecting a call by sensing a vital signal, as disclosed in Korean Patent No. 10-0259041, suffers from the same problem encountered with the scheme illustrated in FIG. 2.

FIG. 3A illustrates the structure of a conventional pressure sensor 300 and FIG. 3B illustrates pressure sensors 300 on both side surfaces of a mobile terminal. The pressure sensor 300 includes a pressure device 301 for generating a signal by being transformed by pressure and members 302 positioned on and beneath the pressure device 301, serving as supports or electrodes. The pressure device 301 may be a piezoelectric device for converting pressure to electricity, an Anisotropic Conductive Film (ACF) for conducting electricity between upper and lower metals by pressure, or a device formed of a dielectric material having a restoration force, such as silicon, for measuring a capacitive variation caused by a pressure-incurred change in the distance between upper and lower metals.

When the pressure sensors 300 are installed on both inner side surfaces of the mobile terminal to sense the user's grip on the mobile terminal, as illustrated in FIG. 3B, fixtures 310 are additionally required to fixedly support the members 302 of the pressure sensors. In addition, if the pressure sensors 300 are elongated along the side surfaces of the mobile terminal, for sensing a grip on the mobile terminal, the overall width of the mobile terminal undesirably increases due to the thicknesses of the pressure sensors 300 and the fixtures 310 supporting them.

### SUMMARY OF THE INVENTION

An aspect of embodiments of the present invention is to address at least the problems and/or disadvantages and to provide at least the advantages described below. Accordingly, an aspect of embodiments of the present invention is to provide a method and apparatus for fast switching to a manner mode by sensing a user's grip on a mobile terminal, upon incoming of a call, and automatically connecting the incoming call when the mobile terminal is adjacent to the user's face or ears.

Another aspect of embodiments of the present invention provides a method and apparatus for enabling a user to identify a caller and communicate with the caller in a manner mode or enabling the user to immediately communicate with the call without checking the caller's number when the mobile terminal is placed adjacent to the user's face or ears, so that a call is conveniently conducted without the need for pressing a button in the mobile terminal or opening the mobile terminal, in a sliding type or a folder type terminal.

A further aspect of embodiments of the present invention provides a method and apparatus for fast switching to a manner mode and connecting a call by sensing a hand pressure, upon incoming of a call while a user grips a mobile terminal.

In accordance with an embodiment of the present invention, there is provided a method for performing a call by sensing a user's grip on a mobile terminal, in which the mobile terminal is switched to a manner mode, when grip sensors on both side surfaces of the mobile terminal are simultaneously touched, upon incoming of a call, the call is started, if a vicinity sensor senses the user's face nearby in the manner mode, and the call is ended, if the vicinity sensor senses that the user's face is receding from the mobile terminal.

In accordance with another embodiment of the present invention, there is provided an apparatus for performing a call by sensing a user's grip on a mobile terminal, in which grip sensors are installed on both side surfaces of the mobile terminal and senses a user's grip on the mobile terminal, and a vicinity sensor senses that the user's face is approaching or receding from the mobile terminal. If the grip sensors sense the user's grip simultaneously, upon incoming of a call, the mobile terminal is switched to a manner mode. If the vicinity sensor senses the user's face nearby in the manner mode, the call is started. If the vicinity sensor-senses that the user's face is receding from the mobile terminal, the call is ended.

### BRIEF DESCRIPTION OF THE DRAWINGS

The above and other objects, features and advantages of certain embodiments of the present invention will be more apparent from the following detailed description taken in conjunction with the accompanying drawings, in which:

FIG. 1A illustrates a conventional mobile terminal for fast switching to manner mode using an acceleration sensor;

FIG. 1B illustrates a conventional mobile terminal for fast switching to manner mode using a temperature sensor;

FIG. 2 illustrates a conventional mobile terminal for sensing a user's grip on the mobile terminal by a temperature sensor and automatically connecting a call;

FIG. 3A illustrates the structure of a conventional pressure sensor;

FIG. 3B illustrates a mobile terminal having installed therein the conventional pressure sensors;

FIGS. 4A-4D illustrate a method for, upon incoming of a call, fast switching to a manner mode by sensing a grip on a mobile terminal and automatically connecting the incoming call by recognizing a user's face adjacent to the mobile terminal according to an embodiment of the present invention;

FIG. 5 illustrates buttons installed on both side surfaces of the mobile terminal, for switching to the manner mode according to an embodiment of the present invention;

FIG. 6 illustrates an arrangement of grip sensors for sensing a grip on the mobile terminal and pressure sensors for sensing a grip pressure in the mobile terminal according to an embodiment of the present invention;

FIG. 7 illustrates a pressure sensor attached onto a side surface and a bottom surface, or onto a side surface and a top surface inside the mobile terminal according to an embodiment of the present invention; FIG. 8A illustrates contraction of a strain gage being a pressure sensor and decrease of the resistance of the strain gage, when a grip pressure is applied to both side surfaces of the mobile terminal, when the strain gage is at the center of the top or bottom surface of the mobile terminal; and

FIG. 8B illustrates expansion of a strain gage being a pressure sensor and increase of the resistance of the strain gage, when a pressure is applied to the top surface of the mobile terminal, when the strain gage is at the center of the top or bottom surface of the mobile terminal

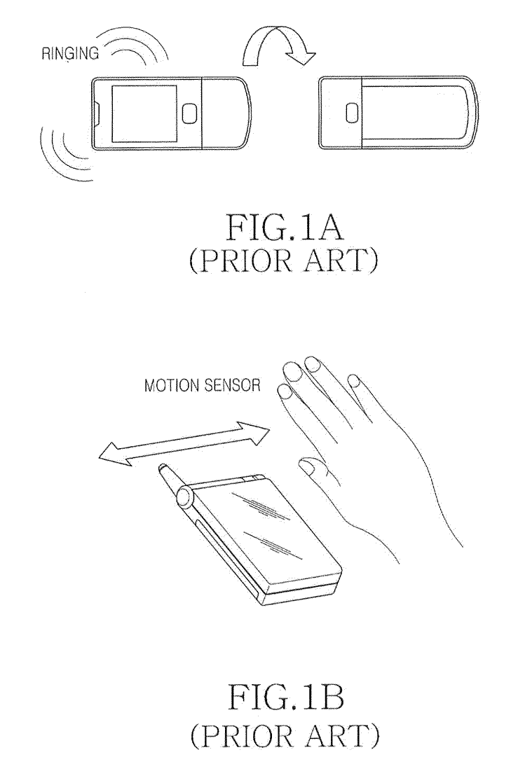

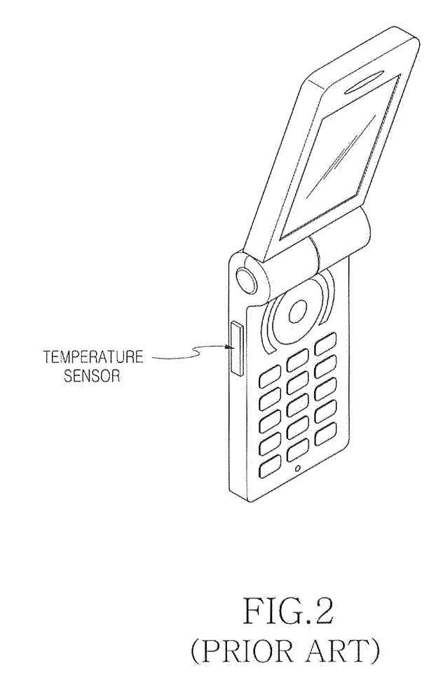

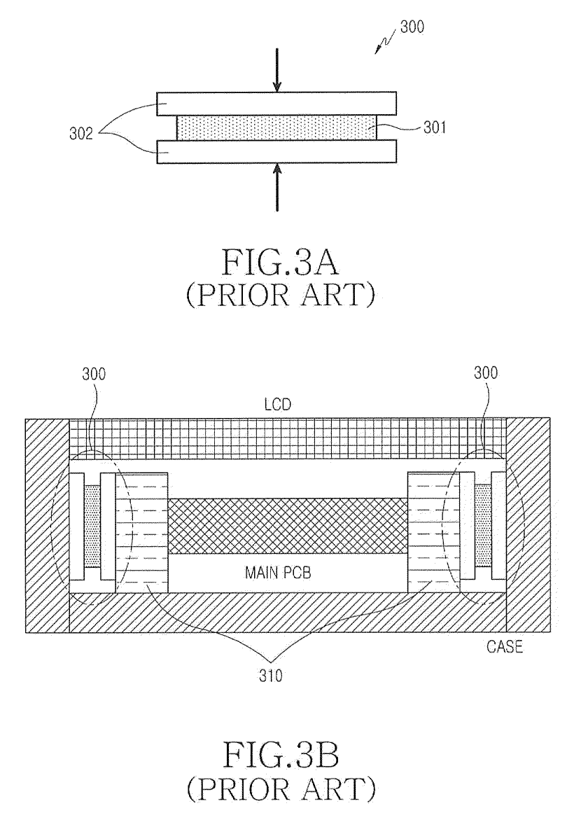

Throughout the drawings, the same drawing reference numerals will be understood to refer to the same elements, features and structures.

### DETAILED DESCRIPTION OF EMBODIMENTS OF THE INVENTION

The matters defined in the description such as a detailed construction and elements are provided to assist in a comprehensive understanding of embodiments of the invention. Accordingly, those of ordinary skill in the art will recognize that various changes and modifications of the embodiments described herein can be made without departing from the scope and spirit of the invention. Also, descriptions of well-known functions and constructions are omitted for the sake of clarity and conciseness.

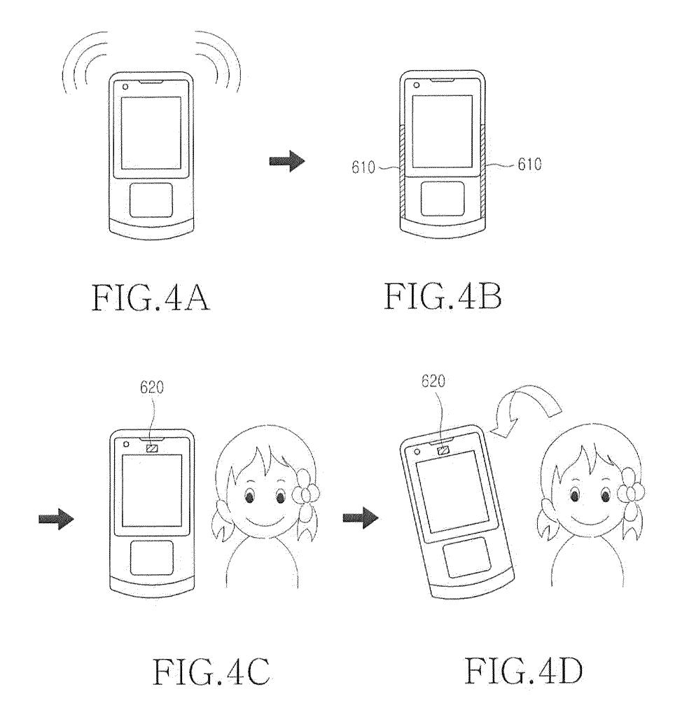

FIGS. 4A-4D illustrate a method for, upon incoming of a call, fast switching to a manner mode by sensing a grip on a mobile terminal and automatically connecting the incoming call by recognizing a user's face adjacent to the mobile terminal according to the present invention.

Referring to FIG. 4, upon receipt of an incoming call, the mobile terminal rings or vibrates, as indicated in FIG. 4A. As shown in FIG. 4B, when a user grips the mobile terminal, grip sensors 610 at both side surfaces of the mobile terminal sense the user's grip and thus the mobile terminal switches to a manner mode.

In FIG. 4C, after switching to the manner mode, when the mobile terminal is adjacent to the user's face or ears, a vicinity sensor 620 installed in a speaker portion senses the user's adjacent face or ears. Thus, the mobile terminal is connected to the incoming call.

In FIG. 4D, if the vicinity sensor 620 senses that the mobile terminal is receding from the user's face or ears and the grip sensors 610 do not sense a grip on the mobile terminal, the call ends.

The grip sensors 610 and the vicinity sensor 620 may be capacitive sensors, pressure sensors, or optical sensors.

Upon receipt of an incoming call, the mobile terminal alerts the user of the incoming call by bell sounds or vibrations. When the user is in a location where silence is preferred, such as a movie theater, a musical performance, or an exhibition, the bell sounds or vibrations should be terminated immediately. Hence, fast switching to the manner mode is necessary.

For fast switching to the manner mode, two grip sensors are installed on both side surfaces of the mobile terminal, for sensing a grip on the mobile terminal. When both sensors are active simultaneously, it is determined that the user has gripped the mobile terminal.

The grip sensors may operate in a capacitive sensing scheme by sensing a capacitive change in the presence or absence of a grip, a pressure sensing scheme by sensing a grip pressure, or in an optical sensing scheme by sensing a change in the intensity of light incident on a Photo Diode (PD) according to the presence or absence of a grip or according to a grip pressure using a Laser Diode (LD), the PD, and a waveguide between the LD and the PD.

Upon receipt of an incoming call, if the user's hand grips the mobile terminal from a remote place such as a pocket or a table, the mobile terminal is fast switched to the manner mode. If the mobile terminal is held in the user's hand when an incoming call is received, the grip is sensed simultaneously with the receipt of the incoming call. In this case, the user does not recognize the incoming call. Hence, the manner mode switching is canceled and the mobile terminal rings or vibrates in the same manner as in the case of call termination before the user grips the mobile terminal. The manner mode switching cancellation prevents an error of grip sensing. When two buttons on both sides of the mobile terminal are pressed at the same time, the manner mode may be set.

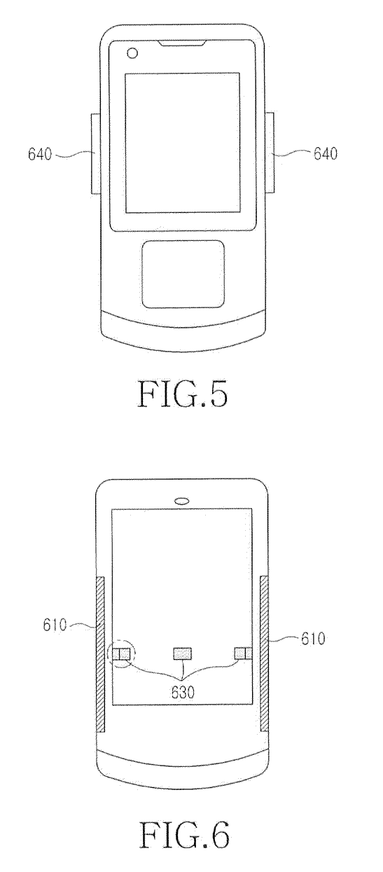

FIG. 5 illustrates buttons installed on both side surfaces of the mobile terminal, for switching to the manner mode according to the present invention. Referring to FIG. 5, if buttons 640 (e.g. a volume button or a camera button) on both side surfaces of the mobile terminal are simultaneously pressed, the manner mode may be quickly set.

The user may check a caller's number in the manner mode. The user releases the mobile terminal when the user wants to reject a call. If no grip is sensed for at least a set time, such as for at least two (2) seconds, a notification message that the called is not available is transmitted to the caller.

Even though the user may re-position the mobile terminal in hand after the manner mode is set, the manner mode is maintained if no grip is sensed for less than the set time, such as for less than two (2) seconds.

When the mobile terminal approaches the user's face or ears in the manner mode, which is sensed by the vicinity sensor positioned in the speaker portion of the mobile terminal, the call is automatically connected. Thus, the user can conveniently communicate with the caller without the need for pressing a Call button, sliding a slide-type mobile terminal, or opening a folder-type terminal. When the button is pressed, the mobile terminal slides up, or the folder is opened up in the manner mode, the call is also connected.

If the user's grip and the vicinity of the user's face or ears to the mobile terminal are sensed simultaneously, that is, if the grip sensors 610 on both sides of the mobile terminal and the vicinity sensor 620 in the speaker portion simultaneously sense the grip and the vicinity, the terminal is switched to a manner mode but the call is not connected.

As the user re-holds the mobile terminal, but the mobile terminal is receded from the user's face, and is then placed adjacent to the user's face for communication with the caller, the vicinity sensing is off and then on again. This results in the connection of the call.

For example, the user may grip both sides of the mobile terminal to switch the mobile terminal to the manner mode, when the mobile terminal is placed in a pocket or a bag. If the user's finger inadvertently touches or covers the vicinity sensor (for face recognition), the mobile terminal is switched to the manner mode and the call is connected immediately, because the vicinity sensor senses the fingers as a face. Consequently, the user may not identify the caller and determine whether to accept or reject the call before the call connection.

To avert this problem, when the grip and vicinity are sensed simultaneously or within a very short time, such as within 0.2 seconds, it is determined that the vicinity sensor is inadvertently touched. Thus, only the manner mode switching takes place without the call connection.

Generally, when the user checks the caller's number, the user re-holds the mobile terminal to conveniently communicate with the caller. In this situation, the vicinity sensing is off. When the mobile terminal is adjacent to the user's face, the vicinity sensing is on, thus connecting the call.

When the communication ends, the mobile terminal recedes from the user's face or ears and is released from the grip. Hence, the call ends. The call also ends by pressing an End button. If the user does not grip the mobile terminal during the call, the call may not be ended by simultaneously pressing the buttons on both side surfaces of the mobile terminal. The vicinity sensor for face recognition may operate in any of the capacitive, pressure sensor or optical sensor schemes.

Various user interfaces may be configured by sensing a grip on the mobile terminal and sensing an intentionally applied pressure after the grip. For example, in a video call, the mobile terminal is switched to the manner mode when the mobile terminal is gripped. When pressure is intentionally applied, the call may be automatically connected.

FIG. 6 illustrates an arrangement of the grip sensors 610 for sensing a grip on the mobile terminal and pressure sensors 630 for sensing a grip pressure in the mobile terminal according to the present invention.

Referring to FIG. 6, the grip sensors 610 may be fabricated by printing a grip sensor metal pattern onto a mobile terminal case or fabricated into a thin Flexible Printed Circuit (FPC) structure of a thickness below about 0.1 mm in order to minimize an increase in the side volume of the mobile terminal. The grip sensor metal pattern is for measuring a grip in the capacitive scheme.

The pressure sensors 630 may be configured with small strain gages or piezoelectric devices and disposed within the mobile terminal.

A strain gage has a long winding special metal pattern between polymer layers, thus having a resistance. If the strain gage is attached to the surface of some material, it is lengthened or shortened in proportion to the expansion or contraction of the material surface. As a result, the resistance of the strain gage is changed. When the strain gage is shortened due to pressure, its resistance decreases, whereas when the strain gage is lengthened, its resistance increases.

As illustrated in FIG. 6, one or more pressure sensors 630 may be positioned at the center or both sides of the top or bottom surface of the mobile terminal case.

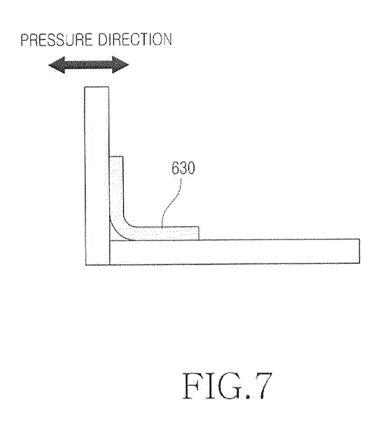

FIG. 7 illustrates the installation of a pressure sensor on the mobile terminal according to the present invention.

Referring to FIG. 7, the pressure sensor 630 is disposed across a side surface and bottom surface or across a side surface and top surface inside the mobile terminal case in order to maximize the capability of sensing pressure with the small pressure sensor 630.

That is, when the pressure sensor 630 is attached at 90 degrees onto the side and bottom surfaces of the mobile terminal case as illustrated in FIG. 7, when the side surface of the case is transformed by pressure, a larger transformation of the strain gage occurs due to the motion difference between the side and bottom surfaces. Thus a larger resistance of the strain gage is realized.

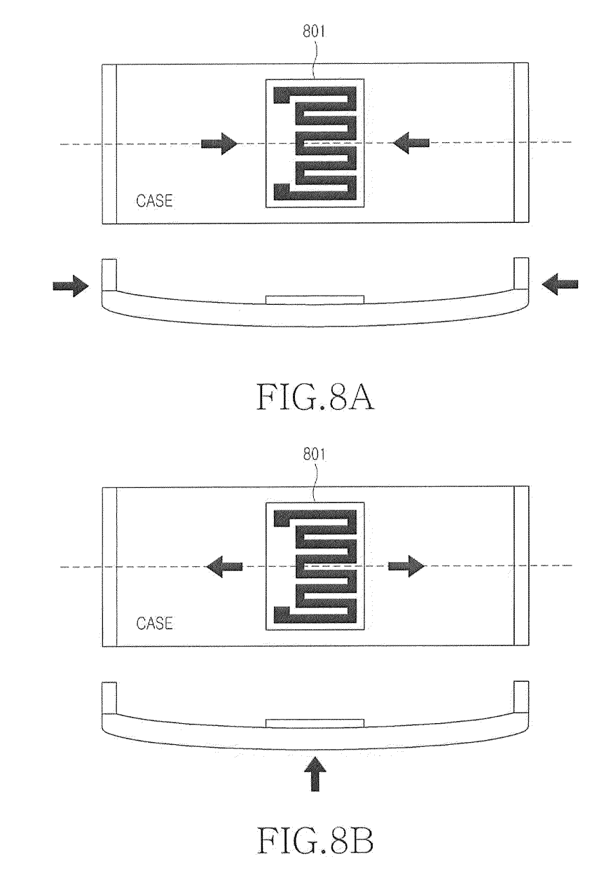

FIGS. 8A and 8B illustrate an arrangement of a strain gage in the mobile terminal according to the present invention.

Referring to FIG. 8A, a strain gage 801 is attached to the center of the bottom surface of the case in the mobile terminal. When a grip pressure is applied, the strain gage 801 is contracted and thus its resistance is decreased.

Referring to FIG. 8B, when a touch screen is touched in a mobile terminal equipped with the touch screen or the strain gage 801 is pressed with the user's fingers or palm during gripping the mobile terminal, the strain gage 801 attached within the mobile terminal is expanded and its resistance is increased. It is determined that the grip pressure has been applied only when the resistance of the strain gage 801 decreases. In this manner, a touch operation error or a grip pressure sensing error may be eliminated.

Calibration of the strain gage 801 is performed after an initial sensing of the capacitive grip sensors.

When the user grips the mobile terminal with pressure, pressure sensing devices for sensing the grip pressure may be placed along both side surfaces of the mobile terminal. However, support members are required to support the pressure sensing devices, thereby increasing the size of the mobile terminal. When a small device such as a strain gage is attached to minimize a terminal size increase, the sensor should be very sensitive. Therefore, calibration of the sensor is essential just before it is used, because of such factors as an attached state of the sensor and a drift related to temperature and humidity. To overcome this problem, four sensors are used in the form of Whiston bridges to compensate for effects of temperature and humidity. Also, an additional temperature compensation circuit may be used.

If the pressure sensors start to operate based on a pressure applied to the mobile terminal when the mobile terminal wakes from sleep mode, they may mistakenly sense an unintentional force for a pressure.

For example, when the user grips a mobile terminal on a desk during enjoying an MP3 function, the pressure sensors may mistakenly sense a pressure change.

To solve this problem, an initial grip is sensed by a capacitive sensor and a pressure sensor is calibrated upon the sensing of the initial grip. Then an intended pressure is sensed as a pressure, when a pressure change per unit time measured by the pressure sensor is large.

If a grip and a grip pressure can be sensed upon incoming of a call, switching, to the manner mode by pressing buttons on both side surfaces of the mobile terminal may be replaced by switching to the manner mode by sensing the grip pressure.

In this case, the user may selectively set pressure sensitivities to large, medium, or small.

A hand input may be used as a new input in transmission mode or in motion User Interface (UI) mode as well as when a call is received in a mobile terminal.

As is apparent from the above description, embodiments of the present invention enable fast and convenient switching to manner mode and allow a user to communicate with a caller, after identifying the caller in the manner mode. Also, the user can communicate with the caller immediately when a mobile terminal is placed adjacent to the user's face or ears without the need for pressing a button, sliding up a slide-type mobile terminal, or opening a folder type terminal. In addition, the mobile terminal can provide a new interface to the user according to sensing of a grip pressure.

While the invention has been shown and described with reference to certain embodiments of the present invention thereof, it will be understood by those skilled in the art that various changes in form and details may be made therein without departing; from the spirit and scope of the present invention as defined by the appended claims and their equivalents.

What is claimed is:

1. A method for performing a call by sensing a user's grip on a mobile terminal, comprising:
switching the mobile terminal to a manner mode, when grip sensors on both side surfaces of the mobile terminal are touched simultaneously, upon receipt of an incoming call;
starting the call, if a vicinity sensor senses the user's face adjacent to the mobile terminal in the manner mode; and
ending the call, if the vicinity sensor senses that the user's face is receding from the mobile terminal.

2. The method of claim 1, wherein the mobile terminal is in ring mode or in vibration mode, upon incoming of the call.

3. The method of claim 1, wherein the vicinity sensor senses the user's face or ears receding from or approaching the mobile terminal.

4. The method of claim 1, wherein the grip sensors are at least one of capacitive sensors, pressure sensors, and optical sensors.

5. The method of claim 1, further comprising:
setting the mobile terminal to ring mode or vibration mode, when the grip sensors sense a grip, upon incoming of the call; and
switching the mobile terminal to the manner mode, when buttons on both side surfaces of the mobile terminal are pressed simultaneously in the ring mode or the vibration mode.

6. The method of claim 1, further comprising automatically transmitting to a caller a voice notification that a called party is not available, when the mobile terminal is switched to the manner mode by sensing a grip, upon incoming of the call, the grip sensing is off as the user identifies a caller and then releases the mobile terminal so as not to communicate with the caller, and no grip is sensed for at least a set period of time.

7. The method of claim 1, further comprising:
switching the mobile terminal to the manner mode, without connecting the call, if the grip sensors and the vicinity sensor simultaneously sense the grip and the vicinity of the mobile terminal to the user's face, respectively, upon incoming of the call; and
connecting the call if the vicinity sensor does not sense an adjacent vicinity of the mobile terminal to the user's face and then subsequently senses the adjacent vicinity of the mobile terminal to the user's face.

8. An apparatus for performing a call by sensing a user's grip on a mobile terminal, comprising:
grip sensors on both side surfaces of the mobile terminal, for sensing a user's grip on the mobile terminal; and
a vicinity sensor for sensing that the user's face is approaching or receding from the mobile terminal;
wherein the mobile terminal is switched to manner mode, if the grip sensors sense the user's grip simultaneously, upon receipt of an incoming call, starting the call, if the vicinity sensor senses the user's face nearby in the manner mode, and ending the call, if the vicinity sensor senses that the user's face is receding from the mobile terminal.

9. The apparatus of claim 8, wherein the mobile terminal is in ring mode or in vibration mode, upon incoming of the call.

10. The apparatus of claim 8, wherein the vicinity sensor senses the user's face or ears receding from or approaching the mobile terminal.

11. The apparatus of claim 8, wherein the grip sensors are at least one of capacitive sensors, pressure sensors, and optical sensors.

12. The apparatus of claim 8, wherein the mobile terminal is set to ring mode or vibration mode, when the grip sensors sense a grip, upon incoming of the call, and the mobile terminal is switched to the manner mode, when buttons on both side surfaces of the mobile terminal are pressed simultaneously in the ring mode or the vibration mode.

13. The apparatus of claim 12, wherein upon incoming of the call, the user's grip is sensed by the grip sensors being capacitive sensors, and the user's pressing is sensed by a pressure sensor after the grip is sensed.

14. The apparatus of claim 13, wherein the pressure sensor includes at least one of a strain gage and a piezoelectric device.

15. The apparatus of claim 14, wherein the strain gage is attached at 90 degrees across a side surface and a bottom surface or across a side surface and a top surface inside the mobile terminal.

16. The apparatus of claim 14, wherein the strain gage is attached on a center of the bottom surface inside the mobile terminal, a grip pressure decreases a resistance of the strain gage, a pressure applied during a touch operation or a grip operation increases the resistance of the strain gage, and only a pressure that decreases the resistance of the strain gage is determined as a grip pressure.

17. The apparatus of claim 14, wherein the strain gage is calibrated after an initial sensing of the capacitive grip sensors.

18. The apparatus of claim 12, wherein the mobile terminal is switched to the manner mode, when the pressure sensor senses a grip pressure, instead of the simultaneous pressing of the buttons on both side surfaces of the mobile terminal.

19. The apparatus of claim 8, wherein when the mobile terminal is switched to the manner mode by sensing a grip, upon incoming of the call, the grip sensing is off as the user identifies a caller and then releases the mobile terminal so as not to communicate with the caller, and no grip is sensed for at least a set period of time, a voice notification that a called is not available is automatically transmitted to the caller.

20. The apparatus of claim 8, wherein the grip sensors and the vicinity sensor simultaneously sense the grip and the adjacent vicinity of the mobile terminal to the user's face, respectively, upon incoming of the call, the mobile terminal is switched to the manner mode, without connecting the call, and if the vicinity sensor does not sense the adjacent vicinity of the mobile terminal to the user's face and then subsequently senses the adjacent vicinity of the mobile terminal to the user's face, the call is connected.
